(19) United States
(12) Patent Application Publication
(10) Pub. No.: US 2010/0201573 A1
(43) Pub. Date: Aug. 12, 2010

(54) Ranging transceiver based activity monitoring system

(76) Inventor: Michael George Lamming, Los Altos, CA (US)

Correspondence Address: RONALD CRAIG FISH, A LAW CORPORATION, PO BOX 820, LOS GATOS, CA, 95032, US

(21) Appl. No.: 12/322,756

(22) Filed: Feb. 6, 2009

(51) Int. Cl. G01S 5/02

(52) U.S. Cl. 342/451

(57) ABSTRACT

A platform for collecting activity data comprising a ranging network of ranging transceivers which discover each others presence, range each other and report ranging and other sensor data via a gateway and data path to a computer which may itself report the ranging data to a remotely located computer. One or the other of the computers is programmed to display a set of primitives each of which is an event recognizer. A user interface allows a user of the computer to compose said primitives into inference rules to analyze activity by applying said inference rules to said ranging data.

### BACKGROUND OF THE INVENTION

Activity monitoring systems are useful for many things including monitoring the movements of patients such as Alzheimer's patients or patients with heart problems, diabetes, cancer or other illnesses. For example, it is useful to be able to remotely monitor the movements within a house of a patient who needs to be monitored by medical personnel but for whom hiring a full time person to be in the home to monitor the person's movements and condition is not an option. Such a system would be able to sense the location within a home of a person and how long the person being monitored was there. For example, if a person whose activity is being monitored goes into the bathroom and stays there for an hour, there is a high degree of probability that something is wrong such as the patient had collapsed, or had a heart attack etc. Further, for Alzheimer's patents, it is useful to know when they leave the house and may get lost. Information gathered from such activity monitoring systems can be subjected to whatever rules are designed for the particular application to which the system is being put for purposes of, for example, raising an alarm and dispatching paramedics to the home of a patient who collapsed.

It would be useful to have activity monitoring systems that can also spot trends in behavior that may not be obvious to the subject, or observers. The changes may be subtle, or might occur very slowly over many years. For example it is known that Alzheimers patients alternate between good days in which they move around normally, followed by bad days in which they tend to sit more, or wander around aimlessly. These differences often get more pronounced during onset. An activity monitoring systems can spot these changes in performace, even at an early stage when they may be too subtle for a human observer, and thus can provide a useful early indication of the disease's onset and progress. It would also be useful to have activity monitoring systems that can tell whether a person is walking, running, sitting or standing and the orientation, i.e., which way the person is facing, and for how long. Such systems are useful for many purposes such as detecting patterns in the behavior of elderly or infirm patients, learning how consumers use products in the home, augmenting reality games, detecting how buildings are used, recording proximity to dangerous chemicals or biological agents, automatic logging of interactions between people at conventions or in the workplace, collecting data for scientific experiements or drug trials, keeping track of the locations of miners in case of a mine collapse, recording the movements of soldiers during training such as in clearing houses during house-to-house fighting in cities for later playback and instruction, finding mislaid objects, tracking the locations of pets and toddlers, reminding people to ensure they do not leave important objects behind, detecting if medications have been taken, etc.

However, just basic activity monitoring systems that can gather data from which it can be determined what person is near what other person or object at what particular time of day and for how long are useful for a wide range of applications.

Some activity monitoring systems are known in the prior art. One such system is an OpenBeacon (RFID tag based) system deployed the-first time under the name of Sputnik. In this system, RFID tag-based OpenBeacon tags are programmed with firmware that either regularly transmits a frame, or regularly switches on the receiver to listen for inquiries received from a base station which is an RFID tag reader. The OpenBeacon tags are always battery powered and cannot act as passive transponders so battery life is an issue. There is not believed to be any motion sensing technology in the OpenBeacon tags to turn the tags on when a wearer of one of the OpenBeacon tags starts to move and his or her location needs to be sensed. In a location tracking system, the OpenBeacon tags will be programmed to regularly transmit beacon packets to the base station which must be within the local vicinity of the tag, i.e. within about 10 meters. The OpenBeacon tags calculate range from the tag to the base station using a technique that adjusts signal strength and uses packet error rate to estimate range. In essence this mechanism is a subtle variation on the common technique of measuring signal strength directly (RSSI) and is assumed to be compromised by the fluctuation of RSSI caused by second-by-second fluctuations in radio propagation characteristics, e.g. the interposition of a human bodies, reflections from walls, or changes in humidty. The beacon packets are modulated onto radio frequency signals so line of sight is not necessary and the packets can travel through walls, but the range is limited.

In a paper published Dec. 28, 2008 at the 25^{th} Chaos Communication Congress, a system to measure proximity of individuals wearing OpenBeacon RFID tags to each other was described. In this system, signal strength of packets received from one or more other OpenBeacon RFID tags by a first OpenBeacon tag is used to measure proximity of the first OpenBeacon tag to the other tags. By reprogramming the OpenBeacon RFID tag firmware to operate bidirectionally over multiple radio channels, proximity sensing of one OpenBeacon tag to another within one meter and 10 second resolution was achieved. In other OpenBeacon systems, the tags operate as simple beacons emitting RF packets for reception by a receiving infrastructure (one or more RFID tag readers). In the social interaction application, OpenBeacon tags exchange messages in a peer-to-peer manner and assess their neighborhood and assess contact with other tags. This data is uploaded to the receiving infrastructure and post processed. Because each packet is coded to identify the tag which sent it, it is claimed that who is talking to whom in a small crowded room can be inferred.

Another such social interaction system is described in a paper by Alain Barrat et al. entitled High Resolution Dynamical Mapping of Social Interactions With Active RFID published 25 Nov. 2008 (arXiv:0811.4170v2) describes a system to use OpenBeacon active RFID tags modified to operate bidirectionally in a peer-to-peer network to do direct contact detection and bypass problems of multiple path signal propagation to the same receiver, phase fluctuation, etc. which limited the precision of spatial location of tags in prior uses. By wearing the tags on their chests, the body PATENT acts as a shield absorbing signals transmitted backwards so that signals transmitted in the direction the wearer is facing will be detected. Reception of packets between the same pair at short range that persisted for more than a few seconds was assumed to be a conversation. A report message was transmitted at a higher power-to report a contact. The reports were stored with a timestamp, the ID of the relaying station and the ID of the tags which participated. Messages between tags were encrypted. Coarse grained filters having time windows of 20 seconds were used for data processing to minimize statistical errors and corresponds to a typical timescale for social interaction.

Visualization of the network where the beacons are nodes and the contacts are edges was used. The model is updated based upon live data feed and the displayed view is updated after each iteration of the algorithm. Receiving stations which were RFID tag readers were placed in places at the conference where social interactions might occur such as the lobby, cafeteria and bar where coffee and lunch breaks occurred during a conference on controlling infectious diseases. Battery failures in the tags were found to be a problem and some beacons disappeared from the data possibly because the wearers left the conference and were no longer within range of the RFID tag readers.

The inventor, while working for HP labs also developed a small autonomous computer called SPEC which could be used in a personal pervasive system as part of a wireless network. The SPEC computer and its uses were described in an article by Lamming et al. entitled SPECs: Personal Pervasive Systems, published in June 2003 in IEEE Computing, at pages 109 et seq. The SPEC (Small Personal Everyday Computer) was an infrared transceiver which could be worn or placed on a stationary object. Data gathered by the SPEC badges could be uploaded to a receiver by infrared transmission if a line of sight connection could be made. The SPEC networks could detect presence of a person in an environment where other SPEC devices were deployed, but all presence sensing had to be by line of sight infrared transmission with a range of about 20 feet as no RF transceiver was present. The SPEC badges also did not have an accelerometer or any other motion sensing hardware so they could not report if the user was moving, stationary, standing or sitting, and could not be put to sleep when motionless thereby consuming battery power while motionless. Each SPEC is powered by two 150 mAh batteries which last about a month with normal use. The SPEC must be worn on the outside of the wearers clothing which reduced their acceptance in many settings.

SPECs discover each other using a peer-to-peer discovery protocol similar to the Xerox Pollen protocol. Each SPEC beacons a 32 bit identifier every two seconds and then listens continuously for other nearby SPEC beacons. When a beacon is received from another spec, a microcomputer on the SPEC records a time-stamped record of the event and stores it in an on-board memory.

SPECs are further described in an article by Lamming et al., SPECs: Another Approach To Human Context and Activity Sensing Research, Using Tiny Peer-to-Peer Wireless Computers, published in 2003 in Proceedings UbiComp 2003. This paper notes the existence of GPS and cell phone systems which detect position and then update and query a central database. The paper notes problems with these other location sensitive systems using GPS or cell phone IDs. GPS systems will not work indoors and cell phone based systems will not work if outside their coverage areas and could be expensive if roaming. In other words, without additional communication facilities two GPS based sensors that knew their own position would not be able to detect the fact that they were proximate to each. If they were indoors they may not even know their own positions, and two cell phone based location sensors would not be able to detect proximity if they were out of their service areas. Each type of sensor would also be relatively expensive since a GPS or cell phone circuit would be involved. Also updates as to proximity of two GPS or cell phone based sensors which are both in a moving car can be complex, especially if the updates to the central database are relatively infrequent and not synchronized.

This paper noted a need for a low cost (less than or equal to $25), long battery life (greater than or equal to one year), small size and light such that it can be worn or carried in a pocket with consistent proximity sensing range. The described system sensed only the proximity of other SPECs and uploaded the contact data to a server for offline analysis. Both RF and IR was considered for the SPECs. On the issue of long battery life, continuous listening turned out to be the challenge as battery life of up to a year was achievable if only transmitting occurred. But a SPEC network is a peer-to-peer network so each SPEC had to continuously listen for others when not transmitting its beacon code. IR transceivers using 150 mAh coin cells were adopted and achieved a battery life of only one month. RF transceivers used ten times as much power than the IR receivers and were rejected on the battery lifetime issue.

### BRIEF DESCRIPTION OF THE DRAWINGS

FIG. 1 is a diagram of a ranging system according to one embodiment.

FIG. 2 is plan view of a typical home environment in which systems within the teachings of the invention may be usefully employed.

FIG. 3 is a block diagram of the preferred type of ranging transceiver using a radio frequency ranging radio and a programmed microprocessor to do a discovery and ranging process.

FIG. 4 is a simplified flow diagram of the basic functions that need to be performed in the discovery and ranging process/protocol.

FIG. 5 is an illustration of a ranging network using RF ranging transceivers one of which is a gateway, a hardwired data path and a computer to receive the ranging data.

FIG. 6 is the packet format for both the broadcast packets and the report packets used in the ranging protocol.

FIG. 7 is an example of an encounter list.

FIG. 8 is an example ranging network for illustration of the multi-hop reporting protocol.

FIG. 9 details the steps of the multi-hop protocol to report ranging data for a ranging transceiver out of range of the gateway transceiver.

FIG. 10 is a flowchart of the discovery and ranging process carried out by a ranging transceiver.

FIG. 11 is a flowchart which contains further details about one of the steps in FIG. 10.

FIG. 12 is a flowchart which contains the details of the listener task carried out by every ranging transceiver.

### SUMMARY OF THE INVENTION

In one embodiment, a peer-to-peer ranging network comprised of wearable ranging transceivers that are small enough to be carried in a pocket or otherwise concealed. These ranging transceivers can determine when they are close to another ranging transceiver and can determine how far away from another ranging transceiver and generate ranging data. The ranging transceiver communicates collected ranging data either in batch mode or in real time to a computer programmed to analyze the ranging data using inference rules which are structured for the particular analysis of activity data desired. The inference rules can be anything and are highly dependent upon the desired information to be learned, the activity to be analyzed and the desired conclusions to be drawn.

How the various functions of the system are physically partitioned among physical computers can vary. In one case, each ranging transceiver can also host the computer which analyzes the ranging data using inference rules or primitives. However, often the computer that analyzes the ranging data using inference rules and/or primitives is separate and remote and coupled to the ranging network by any data path. An example of such a data path would be a gateway transceiver, a hard wired bus coupling the gateway transceiver to a computer which is coupled by a network interface card to a local area network and some kind of modem coupling the LAN to an ISP with the ISP routing packets via the internet from the computer coupled to the LAN to another computer upon which the inference rules are programmed. The choice of where the analysis of the ranging data is done depends on the details of the applications to be supported. Any form of data path may be used to get the ranging data to the computer may be used such as upload to a server over the internet or via a dialup connection or by plugging a gateway transceiver into a computer and having the other transceivers (hereafter called tags) upload ranging data they have stored in onboard memory to the gateway transceiver. The tags may collaborate to forward ranging data back to the gateway. The ranging data must include range data for each encounter between two tags, the identification codes (hereafter tag IDs) of the transceivers and timestamp data which directly encodes the time of the encounter or from which the time of encounter can be derived.

The computer which analyzes the ranging data may be either the first computer to which the ranging data is transferred by the tags or it may be a second computer to which the ranging data is transferred by the first computer.

The computer which analyzes the ranging data may be either custom programmed directly with a program which analyzes the details of the ranging data or it may be programmed with a standard analysis module which displays on the display of the computer a user interface comprised of a set of event recognition primitives which can be composed into application specific inference rules. One form of this interface might broadly resemble the rules-based message filtering interface model used by Microsoft Outlook Express. Each primitive represents a computer program which can analyze the ranging data and recognize an atomic level detail such as tag #6 is within 2.1 meters of tag #3.

The network of tags, data path and computer programmed with the user interface to present a set of primitives is referred to as a platform. In the preferred embodiment, the primitives provided enable construction of a set of inference rules to produce a human recognizable model of context and behavior for the purpose of spotting or recording situations of interest or concern and/or behavioral trends of individuals or populations. For example, primitives are typically provided which allow determination of the time, or sequence of events, location of an event, what ranging transceivers were involved in proximity to each other and the activity type of a subject whose activity is being monitored such as is the subject walking, driving, standing, sitting, sleeping, etc. The primitives typically provided along with the ranging transceivers and the protocols programmed therein to locate other transceivers, range them and upload the ranging data to the computer automatically combine to create a platform which can be integrated with and add significant value to a wide range of different types of sensing applications. The platform can support whole-life activity monitoring applications. In other words, the platform can monitor any aspect of everyday life without significant interruption and continuously in situations where a human observer might eventually lose objectivity or get too tired or where human observers would be too expensive or the presence of the observer might affect the behavior of the subject. The platform can monitor activities for long periods of time and build whole life logs that can be mined to detect long term trends in behavior such as effects of aging or drugs or early detection of the onset of disease. The ranging transceivers can be deployed ubiquitously through the subject's normal domain of operations: home, office, car, shops, gym etc. since the ranging transceivers are small, and, in the preferred embodiment, use RF ranging, so they can be carried in pockets.

The platform represents a general purpose tool to generate ranging data and analyze it in a custom fashion using inference rules composed from the primitives presented in the user interface. The user interface allows several primitives to be concatenated into an inference rule which analyzes the ranging data at a higher level of abstraction to server whatever purpose the platform is being used to support. For example, an inference rule could be composed in an application that monitors old or infirm patients being monitored from a hospital to determine when a medically trained specialist should be dispatched to check in on the patient. As another example, an inference rule could be composed using the user interface of the preferred embodiment that analyzes the ranging data to determine when grandma has been in the bathroom for more than an hour, and raises an alarm or dispatches paramedics when such an event has occurred. The provision of these primitives and a user interface to use them to compose inference rules provides a platform that is useful right away after acquisition and requires no complex programming. The platform supports both individual and populations with a linear cost of growth function. In a way, the platform can be thought of as an event web server in that the events detected by the ranging transceivers and which are reflected in the ranging data can be uploaded to a remote computer or another server for remote observation of the subject by caregivers many miles away. This provides a low cost means of monitoring patients in their homes so as to lower the cost of health care.

The preferred embodiment of a system within the teachings of the invention provides a Touchstone Tag™ which includes an integrated circuit radio frequency transceiver unit, supporting integrated circuitry coupled to the RF transceiver and one or more batteries to power the tag. The supporting circuitry includes onboard memory, an accelerometer or other motion sensor circuitry to sense when the tag moves and turn on the other circuits on the tag that are not always on so as to enable discovery, ranging and storage or upload of the ranging data. Any kind of battery saving technology can also be used in other embodiments to prevent constant battery drainage such as synchronizing all tags to an external clock source and waking all tags up periodically to do discovery and ranging and storage or upload of the ranging data.

The Touchstone tag™, in the preferred embodiment, also includes an integrated programmed microprocessor to, among other things, interface with the RF transceiver to cause it to transmit ranging requests and respond to ranging requests from other units, and do time of flight ranging calculations on data received from the transceiver, and to do filtering and store the results and upload the range results to a base unit.

The ranging is done, in the preferred Touchstone embodiment, by using an algorithm to calculate the range from the time of flight of chirp modulated ranging packets transmitted from other Touchstone tags™ which may be located in particular rooms of a house, the user's car, on the user's medications, etc. or on the person or persons be monitored. The ranging packets contain data which identify the Touchstone tags™ which transmitted the packet and they contain a timestamp as to when they were sent. The timestamp data indicates also when the encounter occurred.

Each tag contains on-board memory in the preferred embodiment and a means to analyze the data, and/or circuitry to upload ranging data via a gateway tag to an analysis computer. In the latter case, the gateway tag is coupled by any means, preferably by an RS232 or USB serial connection to a computer and uploads ranging data from all tags to the computer. The computer may either upload the ranging data to a server which is programmed with inference rules or the computer coupled physically to the gateway tag may itself be programmed with the inference rules.

### DETAILED DESCRIPTION OF THE VARIOUS EMBODIMENTS

### The Ranging Data and Ranging Transceivers

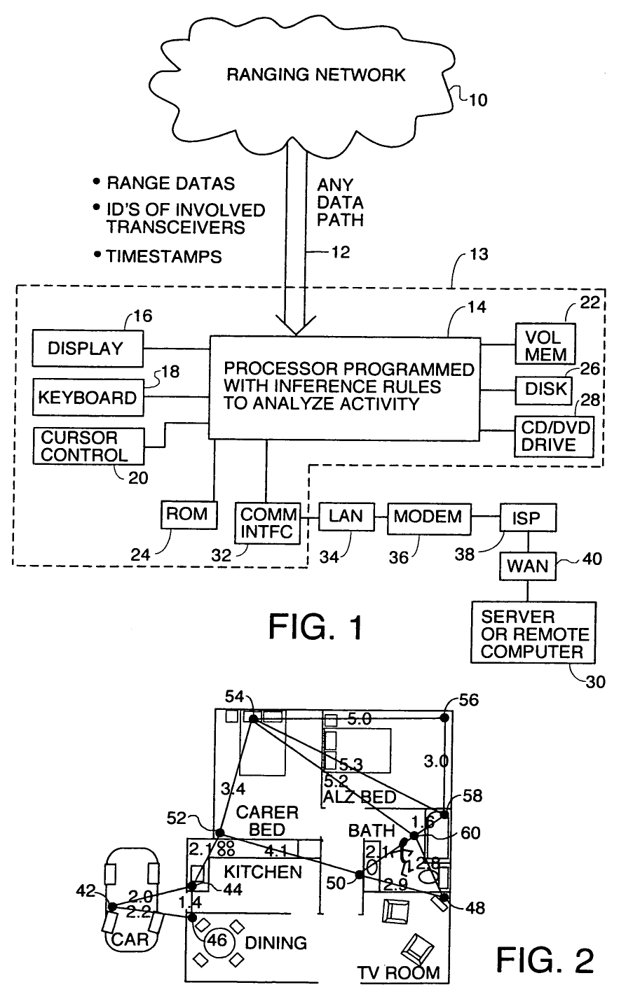

FIG. 1 is a diagram of a ranging system according to one embodiment. A peer to peer ranging network 10 is comprised of a plurality of ranging transceivers. Each of these transceivers has the functional capability to discover other ranging transceivers nearby, determine how far away they are and generate ranging data for the encounter and timestamp the data with the date and time of the encounter. The ranging transceivers each have a unique ID and may hereafter be referred to as tags even though the transceivers in network 10 may not be active or passive RFID tags. The unique ID of each transceiver involved in a ranging encounter identifies the transceivers involved in the encounter, and is included in the ranging data. The ranging data also includes a timestamp which indicates the time of the encounter.

Any type of ranging transceivers may be used in this embodiment including RFID tag transceivers, UWB or infrared based transceivers so long as they can generate ranging data which includes: 1) the range between the transceivers; 2) the time of the encounter; and, 3) the IDs of the transceivers involved and can either store this data for later analysis or upload it immediately to a computer (13 or 30) by any data path 12.

The ranging data is uploaded to a computer 13 via data path 12. The data path 12 represents any way of getting the ranging data to computer 13. The ranging transceivers or “tags” in ranging network 10 and analysis computer(s) 13 could be one and the same, and the datapath 12 could be simply a bus connection This data path may represent each transceiver in network 10 uploading its ranging data to computer 13 via any wired, or wireless link or each transceiver in the network 10 uploading ranging data to a gateway transceiver which is either constantly connected to computer 14 or which is connected to computer 14 from time to time by a physical bus connection such as a USB or SCSI or any other kind of bus or an RS232 connection or by a wireless link, or a uSD storage card hand carried to the analysis computer The term “data path” in the claims includes this hand carried form of delivery of data.

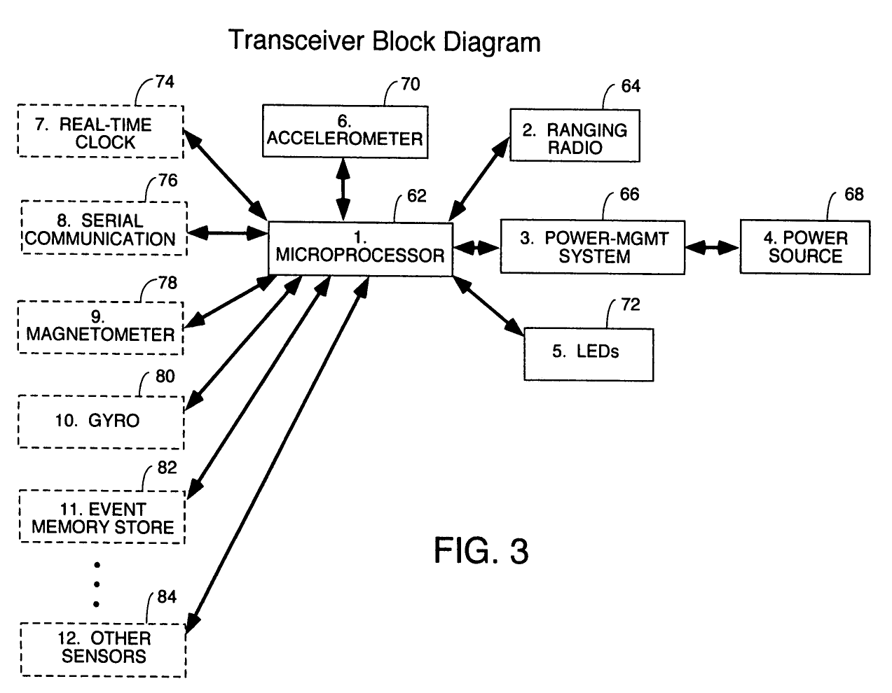

The computer 13 in FIG. 1 may either be a client computer coupled by the internet or some other data path such as a T1 line etc. to a server computer 30 programmed with inference rules or the computer 13 may itself be programmed with inference rules by which the ranging data is analyzed. In other words, the computer 13 may be programmed simply to be an event server to receive the ranging data and forward it via the communication means to the remote server or computer 30 which is programmed to provide the user interface or API with the primitives. The remote server or computer 30 is then used for remote monitoring of the subject by a user thereof who can compose any set of inference rules needed to monitor the activities of the subject in whatever domain or domains the ranging transceivers are deployed. In some embodiments, the processor 14 programmed with inference rules to do the ranging data analysis may integrated on each tag in ranging network 10. In some embodiments, the tags in ranging network 10 may be cell phones modified to have circuitry such as that shown in FIG. 3 or equivalent to do ranging.

The computer 13 is typically comprised of a processor 14 coupled by data, address and control buses or separate data, address and control paths on a single bus (not separately shown) to a plurality of peripheral devices. The computer includes a display 16 upon which tools of a user interface may be displayed and invoked to search for data, display commands representing services which can be launched, program inference rules to analyze the ranging data, display data resulting from searches, etc. A keyboard or other input device 18 can be used to interact with processor 14 to enter data and commands. A cursor control device 20 can be used as part of the user interface to interact with the processor 14 to launch services, make selections etc. Typically, computer programs to control processor 14 are read into volatile memory 22 such as RAM from non volatile memories such as Read Only Memory 24, hard disk 26 or a Compact Disk or DVD read by CD/DVD drive 28. The computer can communicate with a server 30 to upload or download data and programs via a communication interface such as a network card, a local area network 34 (optional), a modem 36 such an a cable modem, DSL modem, Uverse modem, satellite modem, etc., an Internet Service Provider 38 and a wide area network 40 such as the internet. In an embodiment where the ranging data is analyzed by inference rules in server or remote computer 30, the data path 12 includes the computer 13, the communication interface 32, the optional local area network 34, the modem 36, the ISP 38 and wide area network 40. In the claims, the term “communication means” includes the network interface circuit 32, the local area network 34 if one is used, a modem 36 of a kind suitable for whatever communication link to the ISP 38 exists, ISP 38 and whatever wide area network 40 is being used such as the internet, a dedicated WAN; a T1 or better connection and the telephony switching circuits that connect computer 13 to the WAN interface circuits of server or remoted computer 30, virtual private network, microwave link, a satellite link or any other wide area network.

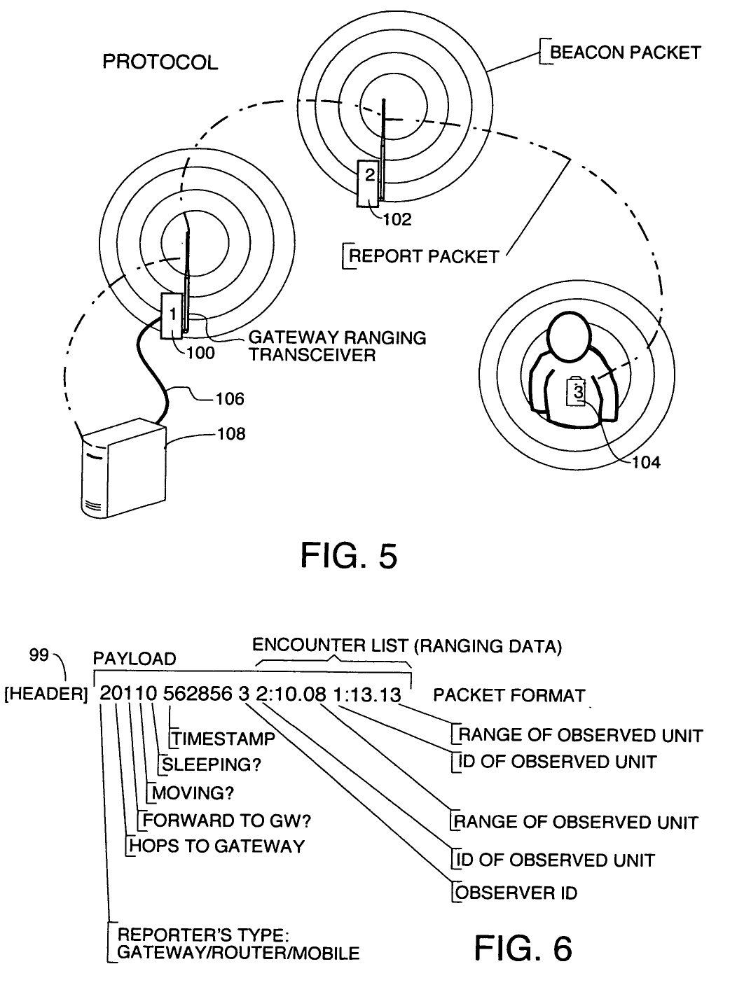

In some embodiments, computer 13 or remote server 30 (whichever one is being used to analyze the ranging data) is a web-server that a) presents the rules specification interface (the primitives and tools to compose inference rules from the primitives) as a web-page, and b) receives data from the gateway (100 in FIG. 5), applies the inference rules and presents the results in the form of another web-page/text message. The computer 14 which analyzes the ranging data may be either the first computer to which the ranging data is transferred by the tags or it may be a second computer such as server 30 to which the ranging data is transferred by the first computer 13. The computer which analyzes the ranging data may be programmed directly by a user who is interested in analyzing ranging data in a particular way for some particular application such as seeing how a product is used in a home. Such a user writing a program would have to have a detailed knowledge of the format of the ranging data packets, the ranging network ID codes, where the various transceivers are located and their roles, and the response characteristics of the ranging system, and other sensors such as accelerometer etc. so as to be able to analyze the significance of combinations of sensor reports produced by each tag. The main challenge to overcome is the signal processing of the raw sensor/ranging data, which requires a deep understanding of the behavioral physics of the ranging transceivers. Provision of a set of primitives from which inference rules can be composed relieves the user of the platform from the need to have a deep understanding of the behavioral physics of the ranging transceivers. Examples of an observer's sensor report might be include a field containing the observer's ID, a field containing the observed ID, and a field containing the range of the observed unit measured by the observer unit. During analysis of this report by the analysis computer following user-defined rules this information might be interpreted as Grandma is near the back door.

Another sensor report might additionally contain a field indicating whether a tag is or is not moving. This may be analyzed to reveal that Grandma is in her bedroom, but out of bed, or in bed and has not moved, even slightly, for many hours!

### The Platform

In the preferred embodiment, it is desirable to free the user of the system from the need to have detailed knowledge of the field format of the ranging data packets, the format and significance of various data within the fields, the behavioral physics or the ranging radio, or other sensors, the ID codes of the various transceivers and where the various transceivers are located. In such an embodiment, the computer 14 is programmed with a computer program that provides a user interface at a higher level of abstraction so as to allow a user to program the computer with inference rules and work in the conceptual solution space and not down in the detail space at the physical layer. This computer program will be called the platform program because it turns the system into a general purpose platform that can collect ranging data and analyze that ranging data in any way suitable for the purpose for which the system is being used by using inference rules that are easy to program by a user using primitives provided by the user interface.

In such an embodiment, the platform program is read into RAM 22 and executed there from which displays on the display 16 a user-interface. The user interface is comprised of a set of primitives which can be composed into inference rules. Each primitive represents a computer program or subroutine which can analyze the fields in ranging data packets and recognize an atomic level detail such as those described above.

The network of tags, data path and computer programmed with the user interface to present a set of primitives is referred to as a platform. The platform represents a general purpose tool to generate ranging data and analyze it in a custom fashion using inference rules composed from the primitives presented in the user interface. The computer program in this preferred platform embodiment provides a user interface which allows several primitives to be concatenated into one or more inference rules. These inference rules analyze the ranging data at a higher level of abstraction to serve whatever application the platform is being used to support.

### Example of Exemplary Primitives and Inference Rules for Remote Monitoring of Old or Infirm Patients

For example, an inference rule could be composed in an application that monitors old or infirm patients being remotely monitored in their home environment from a hospital to determine when a medically trained specialist should be dispatched to check in on the patient. FIG. 2 represents, in the form of a floor plan of a house, an environment in which transceivers can be placed to sense the activities of a patient being remotely monitored. Transceiver 42 is placed in the patient's car. Transceiver 44 is placed in the patient's kitchen attached to her medications. Transceiver 46 is placed in the patient's dining room. Transceiver 48 is placed in the TV room of the patient. Transceiver 50 is placed in the hallway of the home. Transceivers 52 and 54 are placed in the first bedroom, and transceiver 56 is placed in the second bedroom. Transceiver 58 is placed in the bathroom, and transceiver 60 is worn by a user who happens to be in the bathroom in the example of FIG. 2.

In such an application, suitable primitives could be concatenated together to form an inference rule that looks for data in the ranging packets which indicates Grandma is in the bathroom and has not moved in more than an hour. Such an inference rule could be created to trigger an alarm or dispatch paramedics to Grandma's address.

Another example of primitives and concatenating certain primitives to create inference rules would be as follows.

### Example Primitives:

Assume for the following example that G and M are the unique identification numbers of transceivers in the home environment of FIG. 2.

Also assume that G and M are within 0.5 meters of each other and all other nodes are further apart. A first primitive in the user interface that is displayed for selection and concatenation with other primitives to compose a higher level inference rule would be:

proximity (G, M, 0.5)
will return TRUE if the distance between G and M is less than 0.5 meters, otherwise it returns FALSE

A second primitive could be to determine if transceiver M is moving. For this primitive, if M is moving:

acceleration (M, 0.1)
will return TRUE if the unit's acceleration changes by more than a threshold value of 0.1 g (a small movement), otherwise it returns FALSE

### Example Composition of Primitives to Form An Inference Rule

If G is worn by Grandma (transceiver 60 in FIG. 2), and M is attached to her medication bottle (transceiver 44 in FIG. 2) an example inference rule:

proximity (G, M, 0.5) AND moving (M, 0.1)

would return TRUE if Grandma was close to her medication bottle, and the medication bottle was being moved around indicating a high probability that Grandma was taking her medication.

A user using the primitives offered by the platform program might compose Inference Rules that are meaningful to a “Home Care” remote monitoring application as follows:

boolean TakingMeds( ) {return proximity (G, M, 0.5) AND moving (M, 0.1)}

And the Home Care application might inform a remote monitoring site if this event of Grandma taking her medication is spotted in the following manner:

```
    void CheckMedsTaken( ) = {
        if (TakingMeds( ))
                    report(monitoringChannel, “Grandma is taking
her medication”).
    }
```

The “report” primitive composes a report containing the time of the event and the text string, and transmits it on the channel called “monitoringChannel”. The channel is an output stream that was previously configured to deliver output to a specified location. Typically this takes the form a standard stream, which may deliver the output to a file, a web-server, or web-client, a database, a display. A report may be generated in XML format to aid subsequent analysis, or any other convenient format. The above might generate the following fragment:

<report time=“10456904371” message=“Grandma is taking her
medication” />

which reports the time of the event expressed in milliseconds since some epoch.
Example of a Inference Rule to detect a Trend

Building on the previous example reports can be stored in a file or database for trend analysis. The following is an example of a call to the report function to send the latest report to a database.

report (medDB, “Grandma is taking her medication”);

If we want to detect whether Grandma is taking her medications at the same time each day, or if she is slowly trending later each day, the “slope” primitive might be used:
slope (medDB, “time”)

The slope primitive reads the specified field, from all the specified records from the specified input stream—in this case the database where the meds reports have been accumulated. Using a standard line fitting technique, for example a commonly used least squares method, it computes the equation for for a straight line that has the best fit to data. The slope function returns the slope of the line. If the slope is substantially less than 86400000 (the number of milliseconds in a day) minus some threshold amount, for example 60000 which is a minute expressed in milliseconds, then grandma is trending later in the day and it should be reported. The rule might look like this:

```
CheckTrendingLater( ) {
    if ( slope(medDB, “time”) < (86400000-60000) )
        report(monitoringChannel, “Grandma must take her
meds earlier”)
}
```

A variety of different trend primitives exist that attempt to find linear, or harmonic trends, or repeating sequences.

### RF Based Ranging Transceivers Including Time of Flight Transceivers

In the ranging network 10, any type of wireless ranging transceiver (RF, infrared or RFID would be examples of wireless ranging transceivers) may be used which can carry out a discovery and ranging process. Active RFID tag receivers are one type of wireless ranging transceiver that may be used in ranging network 10, but the subject whose activity is being monitored must wear a portable RFID tag reader. The meaning of ranging network is broad enough to include a network of RFID tags and a wearable RFID tag reader that reads these RFID tags and determines how far away each tag which is within range by any means such as signal strength or time of flight calculations. The meaning of ranging network also includes both peer-to-peer and non P2P networks where all the ranging transceivers are the same but one includes, in addition to the circuitry and/or software to do the discovery and ranging process, hardware and software designed to make the transceiver also function as a gateway to upload ranging data collected by itself and the other ranging transceivers in the network to a computer programmed to analyze the ranging data using inference rules.

A preferred type of wireless ranging transceiver for ranging network 10 are time of flight RF transceivers an example of which is shown in FIG. 3. These types of RF ranging transceivers transmit and receive radio frequency ranging packets and calculate range between transceivers based upon the speed of light and the propagation time of a ranging packet from one transceiver involved in the encounter to the other plus turnaround time in some embodiments. Many time of flight ranging systems require fixed infrastructure with wired interconnect using mains power to support the tags. In our preferred embodiment the wireless tranceivers are peers of one another, and require no additional infrastructure to support the ranging function, and can all use batteries, which simplified deployment. The term “ranging transceiver” in the claims includes ranging transceivers powered by batteries and ranging transceivers powered from the main power lines or batteries upon power failure and solar powered ranging transceivers and ranging transceivers powered by movement like some wrist watches. Typical time of flight RF transceivers may use ranging packets that include the time of transmission of the ranging packet and the ID of the transmitter and then take note of the time at which the ranging packet was received. The difference between the transmission time and reception time plus a processing time may be used to calculate the range. In some embodiments, each ranging transceiver transmits an acknowledge packet to the ranging transceiver from which a ranging packet was received. The term “ranging” in the claims includes all protocols for ranging using a wireless ranging transceiver.

Ranging data for each successful ranging encounter with another ranging transceiver is stored in on-board memory. This ranging data includes the calculated range, the ID of the transmitter and the ID of the receiver and a timestamp.

In some embodiments, the ranging data is stored in onboard memory for later upload to the computer which analyzes the ranging data. In other embodiments, the ranging data is immediately uploaded in real time to an analysis computer programmed to analyze the ranging data. The term reporting in the claims is intended to cover all embodiments where the ranging data is given at any time and by any protocol and any data path to an analysis computer which may be elsewhere or integrated on the wireless ranging transceiver itself. The analysis done by the analysis computer can be done using inference rules designed for whatever application the system is being used. In some embodiments, the ranging data is uploaded to said computer via another transceiver acting as a gateway, or “multi-hopped” back through a sequence of transceivers to get to the gateway. The gateway collects ranging data from the other ranging transceivers and uploads the ranging data to a computer via any data path.

Referring to FIG. 3, the preferred wireless ranging transceiver comprises a microprocessor 62 programmed with one or more programs that control it to control a ranging radio 64 do the ranging and discovery and discovery process. Microprocessor 62 preferably is a general purpose microprocessor such as an ATMEL ATMega 128 or equivalent. The ranging radio 64 preferably uses chirp modulation and includes a radio transceiver integrated circuit, filters, balun and antenna. The radio transceiver integrated circuit is commercially available. The ranging radio 64, in the preferred embodiment, has an application programmatic interface to which the microprocessor can make function calls and which returns data from which a time of flight interval can be calculated. The microprocessor is programmed to calculate the range from the returned data. In other embodiments, the ranging radio has an onboard microprocessor or other circuitry to calculate the range to another ranging transceiver and just returns the range in response to a function call. In still other embodiments, the computer which does the analysis of the ranging data using inference rules can be integrated on the ranging radio transceiver chip or integrated with the microprocessor 62. Since each ranging transceiver will have its own ranging data and the ranging data received from other ranging transceivers from which beacon packets have been received, some activity monitoring analysis can be done on each ranging transceiver. Since the ranging transceivers do not have very sophisticated transceivers, the inference rules will have to be either fixed or uploaded to the ranging transceiver from another computer upon which the inference rules were composed. However, in still other embodiments, the ranging transceivers could be cell phones like Iphones or Blackberrys with small but sophisticated displays and input devices such that inference rules can be composed on the ranging transceiver itself. The term “analysis computer” in the claims is intended to cover all these embodiments: 1) either where the ranging transceiver has no or a minimal user interface and has an onboard analysis computer which uses inference rules which are either set at configuration and stored in non-volatile memory; or 2) uses an onboard analysis computer which uses inference rules uploaded from a computer upon which the inference rule was composed; or 3) where the ranging transceiver is a cell phone with a user interface and all the circuitry of the ranging transceiver disclosed in FIG. 3 plus an analysis computer coupled to the user interface of the cell phone such that inference rules can be composed on the cell phone user interface.

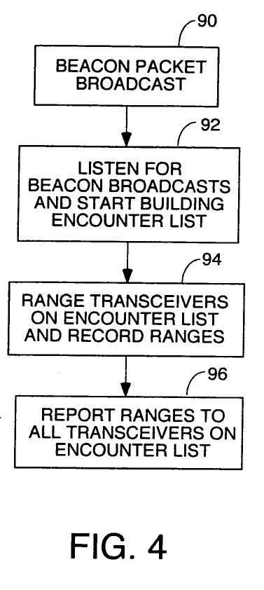

The microprocessor also is programmed to communicate with an accelerometer 70 to sense when the ranging transceiver is moving so as to manage a power management circuit 66 so as to conserve battery power from power source 68 if the power source is a battery. In the preferred embodiment, the accelerometer generates an interrupt to microprocessor 62 when a change in acceleration above a certain threshold is reached. In a mobile tag the microprocessor may be programmed and optionally configured to go to sleep or not after a sleep timer interval expires with no movement of the ranging transceiver. Upon receiving the interrupt upon detection of acceleration above a certain predetermined threshold (which can be configurable in configuration data), the microprocessor wakes up resumes the process of FIG. 4. In the claims, the term power saving means includes the accelerometer and the microprocessor and its programming to go into sleep mode upon a predetermined interval of motionlessness and resume upon receiving an interrupt from accelerometer 70. In addition, the power saving means includes the programming of the ranging transceiver microprocessor to read configuration data, determine if it is a mobile and optionally prevent the mobile from serving as a router.

The power management system 66 monitors the battery voltage in battery-powered versions. Battery powered tags have the means to report the battery status along with other ranging and sensor data so that users can be alerted when the battery is almost exhausted. This accelerometer and programming of the microprocessor to wake up when the accelerometer sends it a signal is preferably only used on mobile ranging transceivers which run on battery power. Ranging transceivers which are scattered about the environment in which the activity of a subject is being monitored can be coupled to AC line power so power conservation is not an issue.

The accelerometer 70 is preferably an ST-Micro LISY300AL. The accelerometer is optional on static ranging transceivers but required on mobile ranging transceivers.

The power source 68 can be a battery for mobiles or a connection to an external power supply unit to supply DC power at the correct voltage or an internal power supply unit coupled to external power lines, or both.

Status LEDs 72 provide a user interface where the number of LEDs lit at any particular time indicate the status of the ranging transceiver.

Status LEDs are also used during deployment to confirm to the person doing the installation if the unit will be able to relay its ranging reports to a gateway. Status LEDs also allow the person doing the installation to know how many other units are in range. Some analysis function may wish to perform a trilateration function for which three or more tags must be in range.

A real time clock 74 provides time information for putting timestamps in ranging data developed from the discovery and ranging process. The clock 74 is optional so long as the microprocessor has some other way of placing timestamp data in the ranging data.

Serial communication interface 76 provides a data path by which ranging data may be uploaded and programs and configuration data may be loaded into nonvolatile memory in microprocessor 62. Typically this is an RS232 , USB, Wireline, Network Interface Card or any RF or infrared link circuitry by which digital data may be transmitted. The serial. communication interface 76 is only necessary for the gateway ranging transceiver and may be omitted from routers and mobiles.

An optional magnetometer 78 is included in some embodiments. The magnetometer communicates heading information to the microprocessor. It is useful to support applications such as monitoring when one person is facing another and is close to them, such as when contacts at a meeting are being monitored. It is also useful to know when two persons or animals are facing the same way and are close.

An optional gyro 80 provides information to the microprocessor regarding the orientation of the ranging transceiver. This useful to support applications such as remote monitoring of aged or infirm patients to detect when they have fallen.

An optional GPS receiver provides a source of location and time. This is useful to support applications that want to record grid-coordinates when the user is outside. It can also provide a source of time for tags that are isolated from the rest of the network.

An optional event memory store 82 stores the ranging data as an encounter list or table. It is optional because the ranging data can also be stored in on-board memory of microprocessor 62. So event memory store will usually take the form of a memory stick or memory card. Usually this store 82 is a nonvolatile memory so that the information will be retained during power down during sleep.

Optional block 84 represents other sensors which could be blood pressure monitors, heart monitors, blood sugar monitors, brain wave monitors, radiation sensors, biological, chemical or nuclear warfare sensors, etc. The type of sensor depends upon the application for which the ranging transceiver is gathering data. The term ranging transceiver in the claims is intended to include wireless ranging transceivers having any combination of the elements described in this section but each ranging transceiver must have a wireless ranging element and all necessary supporting circuitry.

### The Software Processes

The preferred-RF transceiver, time-of-flight ranging protocol involves: 1) discovery of which ranging transceivers are within range by noting whose broadcast packets can be heard; 2) ranging each other ranging transceiver whose broadcast packets can be heard using time of flight calculation; 3) generation of an encounter list which is what has been referred to previously herein as the ranging data; and 4) uploading the encounter list to a computer for analysis or transmission to another computer for analysis. The protocol will be explained in greater detail with reference to FIGS. 4, 5 and 6. FIG. 4 is a simplified flow diagram of the basic functions that need to be performed in the discovery and ranging process/protocol. FIG. 5 is an illustration of a ranging network using RF ranging transceivers one of which is a gateway, a hardwired data path and a computer to receive the ranging data. FIG. 6 is the packet format for both the broadcast packets and the report packets used in the ranging protocol.

In FIG. 5, radio frequency (hereafter RF) ranging transceiver 100 is the gateway ranging transceiver, RF ranging transceiver 102 is a fixed location transceiver and ranging transceiver 104 is a mobile RF ranging transceiver worn by a person whose activities are being monitored. Each ranging transceiver transmits beacon packets periodically or just from time to time. Each beacon packet has the format of FIG. 5 in the preferred embodiment, however in other embodiments, the format of the beacon packet can be simpler such as by eliminating the hop count (for embodiments where multi-hop uploading is not used) and eliminating the encounter list and just using a separate report packet to report the ranging data and by eliminating the Sleeping and/or Moving fields. Each beacon packet includes the ID of the transmitter (Observer ID field) and a timestamp (Timestamp field). Computer 108 is coupled to the gateway ranging transceiver 100 by data path 106 which corresponds to data path 12 in FIG. 1. Computer 108 corresponds to computer 13 in FIG. 1 and is programmed with the inference rules in the embodiment illustrated in FIG. 5 and analyzes the ranging data. However, in other embodiments, computer 108 uploads the ranging data to another computer remotely located (such as server 30 in FIG. 1) via any data path such as the internet for analysis at the other computer.

The basic discovery process portion of the discovery and ranging process is symbolized by blocks 90 and 92 of FIG. 4. Each ranging transceiver transmits beacon packets which function to identify the transceiver with its unique ID and indicate its hop count to the gateway transceiver. The format of the beacon packet (which is the same as the format of a report packet in the preferred embodiment) is shown in FIG. 6. The Observer ID field is the unique ID of the ranging transceiver that sent the beacon packet and must be present in all embodiments. All other fields are optional in various other embodiments.

The hop count to the gateway transceiver is in the Hops to Gateway field. The hop count is only important in cases where the encounter list data has to be uploaded using the multi-hop relay process described below under the Multi-Hop

### Ranging Data Uploading Process.

The basic function of the beacon packet transmission is to allow other ranging transceivers to determine which other ranging transceivers can hear their ranging packet broadcasts and to include timestamp data. Timestamp data is important in the preferred embodiment where the beacon packets actually include the encounter list or ranging data so that if the gateway hears a beacon packet it also receives a report of the ranging data collected by the ranging transceiver that sent the beacon packet. The timestamp data allows computer 108 to analyze the ranging data reported by all ranging transceivers (which may be reported at substantially different times) and determine the sequence of events that can be deduced from the ranging data encounters between ranging transceivers. If timestamps are omitted then the analysis computer must rely on other means to determine the sequence of events—such as the arrival time or sequence of report packets at the gateway or analysis computer.

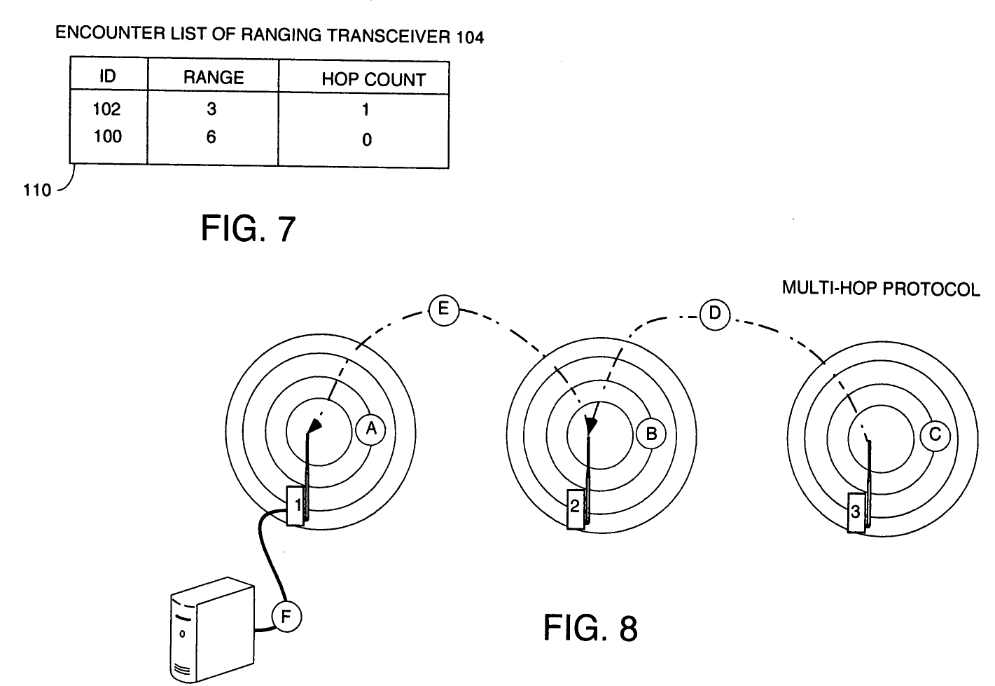

Block 92 represents the process carried out continually in all the other ranging transceivers of listening for beacon broadcasts and starting to build an encounter list. FIG. 7 is an example of the encounter list. In the network of FIG. 5, FIG. 7 is an example of the encounter list of ranging transceiver 104 and assumes that ranging transceiver 104 has heard beacon broadcasts from both the ranging transceiver 102 and the gateway ranging transceiver 100. Each beacon broadcast that is heard by one of the ranging transceivers has its Observer ID entered in column 110. The process of block 92 carried out in transceiver 104 results in the two entries in column 110 of FIG. 7 indicating that transceiver has heard beacons from transceiver 102 and transceiver 100.

Block 94 represents the process carried out by each ranging transceiver of determining the range to each other ranging transceiver for which a beacon broadcast has been heard. This can be by any ranging process. Examples of ranging processes that will suffice are time-of-flight ranging using radio frequency signals, signal strength ranging using radio frequency pulses, and any RF, infrared or ultrasonic ranging process that uses radar techniques of bouncing a signal off an object or sending a signal to a transponder and receiving a reply with the range being calculated based upon time of flight of whatever type signal was sent plus turnaround time, etc. In the preferred embodiment, ranging is done by the microprocessor 62 in FIG. 3 making function calls to an application programmatic interface of ranging radio 64 to retrieve a starting count and ending count of an interval timer and a turnaround time. The ranging radio 64 uses a ranging technique called Symmetrical Double Sided Two Way Ranging which is described in Wikipedia. This ranging technique is known in the prior art and is implemented by commercially available ranging radios such as ranging radio 64. In the preferred embodiment, ranging radio 64 is an NA5TR1 model which is commercially available from Nanotron in Berlin, Germany.

The time-of-flight ranging process for the NA5TR1 is described in detail in “Real Time Location Systems (RTLS) A White Paper from Nanotron Technologies GmgH”. SDS-TWR is similar to the ToF method, but it avoids the need to synchronize the clocks of the ranging transceivers or “nodes” used in ranging measurements. During the SDS-TWR measurements, a signal propagates from one node to a second node AND back to the original node (Round Tripping. The time a signal takes to propogate from Node 1 to Node 2 and back to Node 1 again is measured by Node 1. Time measurements begin in Node 2 only when it receives a packet from Node 1 and then stops its time measurement when it sends a packet back to Node 1. In this case, Node 2 does not need to synchronize its clock with Node 1. When Node 1 receives the acknowledgment from Node 2, the accumulated time values in the received packet are used to calculate the distance between the nodes. The difference between the time measured by node 1 minus the time measured by node 2 is twice the time of signal propagation through the air (a known value) from which the distance can easily be calculated.

When the ranging transceiver 62 requires to know the range of another ranging transceiver (tag) whose identity it knows, it makes a call on the ranging radio's API requesting it to obtain the range to the specified unit. The API uses the above TWR protocol to determine the range which it reports back to the These values are stored by the ranging radio 64 and reported to microprocessor 62 when the microprocessor makes its function calls to the ranging radio API. The microprocessor then calculates the range by calculating the elapsed time between the start and stop counts, subtracts the turnaround time, divides the result by two and converts that time into distance using the speed of light as the constant. The microprocessor 62 records the range it calculates to each other transceiver in its encounter list in the appropriate row of column 112. The actual radio ranging chip 64 used in the preferred embodiment implements three transmissions between transceiver A and transceiver B and has both transceiver A and transceiver B calculate the range. The two ranges calculated by transceivers A and B are then averaged and each transceiver stores that average.

Block 96 represents the process of reporting the-ranging data in the discovery and ranging process. This is done by every ranging transceiver. It can be done by each transceiver sending a report packet to the gateway transceiver 100 if the transceiver is within range of the gateway transceiver. Whether the gateway is within range of the ranging transceiver or not can be determined from the encounter list. If there is an entry in the encounter list with a hop count of zero, that is the gateway. That entry would have been made when a beacon packet was received by the ranging transceiver from the gateway. This is because the gateway knows it is the gateway from its configuration data and sets its hop count to zero in its beacon packets.

If a ranging transceiver is within range of the gateway, the reporting function of block 96 is accomplished each time the ranging transceiver transmits its beacon packet, because each beacon packet includes the full encounter list in the preferred embodiment. That is, in the preferred embodiment, the beacon packets also have the format of FIG. 6 so steps 96 and 90 in FIG. 4 are combined in the preferred embodiment.

In other embodiments, the reporting function is accomplished by sending a separate report packet addressed specifically to the gateway either directly or by the multi-hop relay protocol to be described below. The report packet includes the encounter list and, in the preferred embodiment, has the format of FIG. 6.

The packet format of the beacon packets and the reporting packets in the preferred embodiment includes:

1) a Reporter's type field which is a value which indicates whether the transceiver which sent it is a gateway, a router (any transceiver not functioning as a gateway or a mobile) or a mobile;

2) a Hops to Gateway field which is a value indicating how many hops the transceiver is away from the gateway 100 (useful for other transceivers for determining how to route uploads of ranging data to the gateway);

3) a Forward to Gateway field which contains a value indicating whether the sender wishes the receiving transceiver to forward the encounter list ranging data to the gateway;

4) a Moving field which indicates whether the sending transceiver is moving (useful as a primitive for some applications);

5) a Sleeping field which indicates whether the sending transceiver is about to go to sleep to conserver power such that other transceivers who have the sleeping transceiver in their encounter lists do not waste power and processing time trying to range the sleeping transceiver;

6) a Timestamp field which contains data encoding the time received from the real time clock 74 in FIG. 3;

7) an Observer ID field which contains the ID of the sending transceiver;

8) a first ID of Observed Unit field which contains the ID of a first transceiver which has been ranged and is part of the encounter list;

9) a Range of Observed Unit field which is the range to the ranging transceiver identified in field 8.

Fields 8 and 9 are repeated as many times as are necessary to report all the ranging encounters that the sending transceiver has processed and which are recorded in the encounter list.

Only the payload section of the packet is shown in FIG. 6. The packet also has a header 99 which includes the source and destination MAC addresses in the ranging network (IDs of the ranging transceiver which sent the packet and to which the packet is addressed, respectively) such that the packet can be addressed to the gateway transceiver 100 or to one of the router transceivers if the sender transceiver is not within range of the gateway transceiver 100.

### The Multi-Hop Protocol To Send Ranging Data To The Gateway

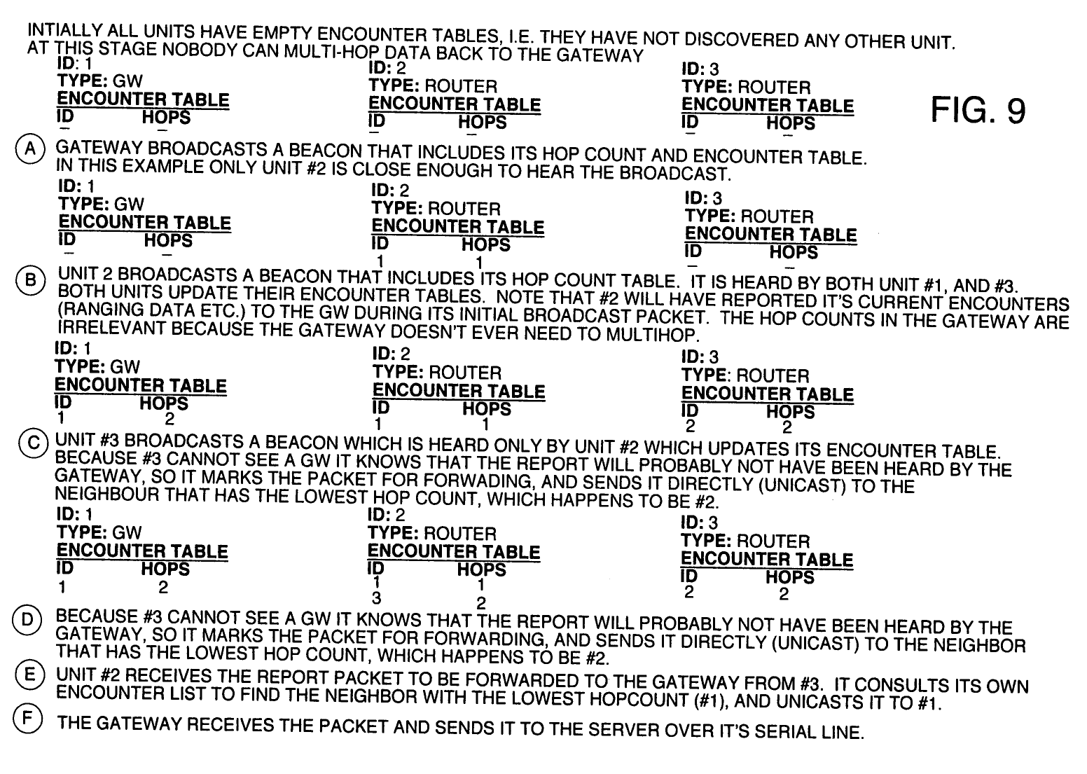

The multi-hop protocol to upload the ranging data in the encounter list is illustrated in FIGS. 8 and 9. FIG. 8 shows an example ranging network with the gateway ranging transceiver as unit #1, the router ranging transceiver as unit #2 and a mobile ranging transceiver, unit #3, which is out of range of the gateway transceiver and which uploads its ranging data through unit #2 because unit #2 is the ranging transceiver in the encounter table of unit #3 with the lowest hop count. FIG. 9 details the steps of the multi-hop protocol to report ranging data for a ranging transceiver which is out of range of the gateway transceiver.

All the gateway, router and mobile ranging transceivers have the same hardware and software, but each functions in a different role based upon configuration data which is loaded into the transceiver when the software is loaded. In the preferred embodiment, loading of the software and upgrades and modifications of the software can be loaded into each transceiver by sending them to the computer 108 which uploads them to the gateway 100 which then sends the software to each ranging transceiver by data packets over the RF link.

Step 96 of FIG. 4, uploading of the encounter list, can therefore be done by sending a data packet (beacon or report packet) containing the ranging data using the ranging radio 64: 1) directly to the gateway; or 2) by sending a report packet or a beacon packet including its ranging data to another ranging transceiver that can see the gateway ranging transceiver with a request to forward the encounter list to the computer.

### The Software Discovery and Ranging and Reporting Processes of the Preferred Embodiment

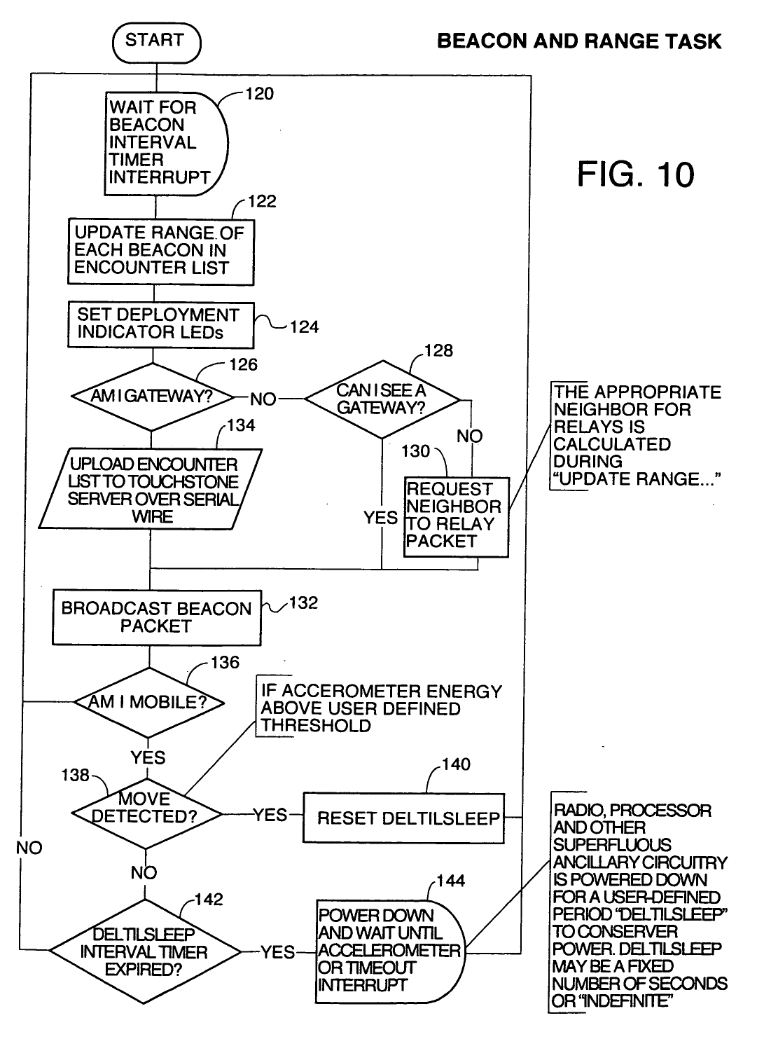

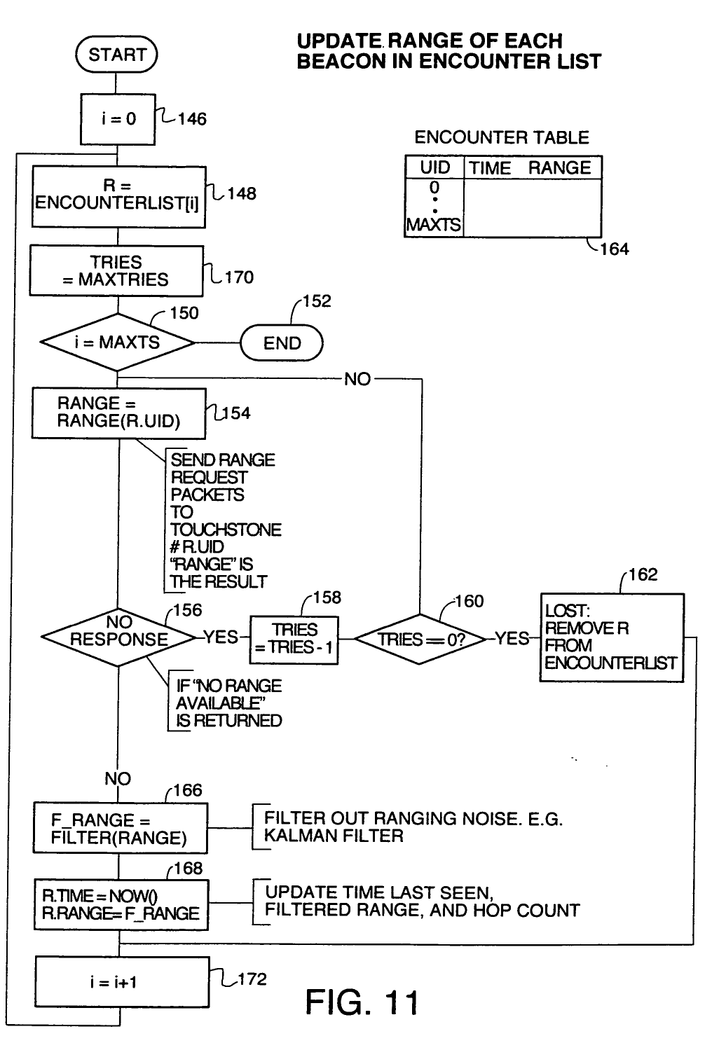

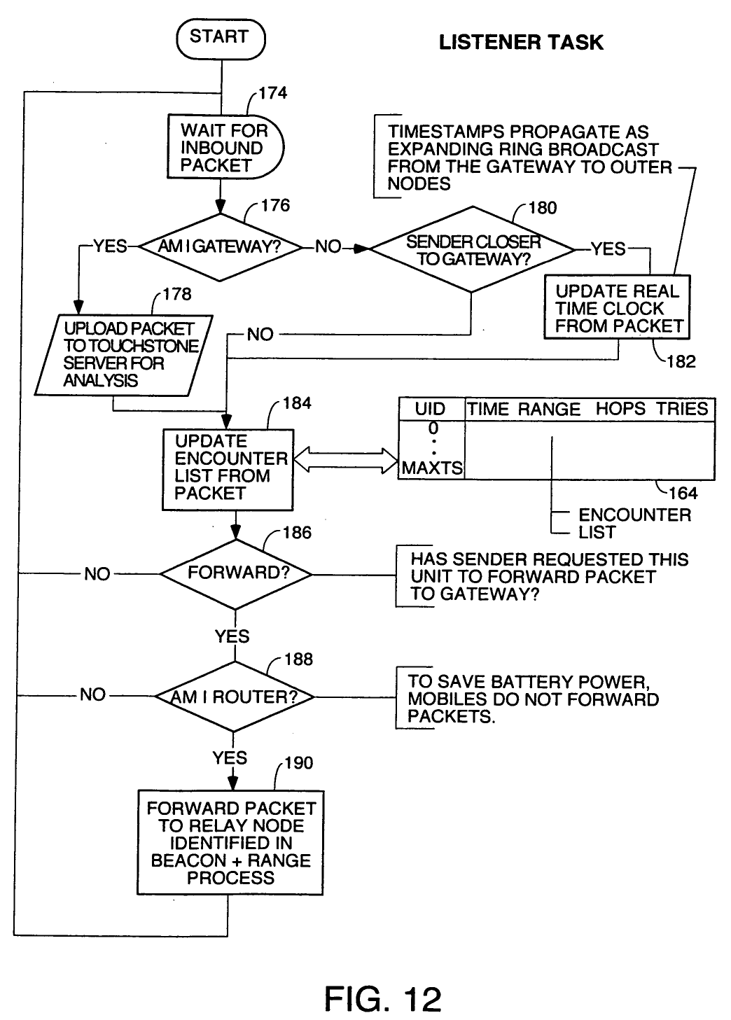

FIG. 10 is a flowchart of the discovery and ranging process carried out by a ranging transceiver. FIG. 11 is a flowchart which contains further details about one of the steps in FIG. 10. FIG. 12 is a flowchart which contains the details of the listener task carried out by every ranging transceiver.

Each ranging transceiver waits for an interval timer to expire, step 120. When it expires, the range to each ranging transceiver in the encounter list is updated using the process of FIG. 11, step 122. Next, the deployment LEDs are lit in accordance with however many ranging transceivers can be seen by the ranging transceiver, step 124. A minimum of three other ranging transceivers must be seen for the ranging transceiver to be able to report its actual location by trilateration. Any other ranging transceiver whose beacon can be heard can be ranged.

Step 126 determines if the configuration data says the ranging transceiver is a gateway. If not, step 128 checks the encounter table to see if a gateway is visible. The gateway would be any ranging transceiver entry with a zero hop count. If the ranging transceiver concludes it is not itself a gateway and it cannot see a gateway, it sends a report packet with its encounter table ranging data to the ranging transceiver in its encounter table with the lowest hop count requesting it to forward the packet to the gateway, step 130 which may involve further hops. If step 128 concludes a gateway is in the encounter list, step 132 broadcasts a beacon packet which includes the ranging data of the ranging transceiver sending the beacon. If step 126 determines the ranging transceiver is itself a gateway, step 134 uploads the ranging data to the computer 108 via the data path 106.

After step 132, test 136 determines from the configuration data whether the ranging transceiver is a mobile. If so, test 138 determines if movement has been detected by the accelerometer. If so, the ranging transceiver will not be put to sleep to save battery power, so step 140 resets the sleep timer. If the ranging transceiver is a mobile and movement has not been detected, test 142 determines if the sleep timer has expired and if the unit can be put to sleep. If not, processing returns to step 120. If the sleep timer has expired, and the unit has been configured to sleep, step 144 puts the unit to sleep. Modern microprocessors can be powered down to an almost dead state such that they will only wake up and resume when an interrupt occurs. That is what is happening in addition to powering down the radio and other ancillary circuitry. When the unit is moved and the accelerometer generates an interrupt or upon expiration of a sleep timeout and a wake up interrupt occurs, processing returns to step 120.

The details of step 122 are shown in FIG. 11. The process of FIG. 11 basically is re-ranging every entry in the encounter table. Step 146 sets an index to 0 to point to the first entry in the encounter table. Step 148 reads the first entry in the encounter list. Step 170 sets the maximum number of tries variable to the maximum and then test 150 determines if the end of the encounter list has been reached. If so, step 152 ends the routine and control returns to step 124 in FIG. 10. Step 154 is the beginning of the ranging loop and represents the microprocessor sending a range unit “uid” function call:to the ranging radio where uid is the argument that identifies which transceiver to range and is the uid of the current entry in the encounter list being re-ranged. The ranging radio returns a range in meters if the try is successful.

Test 156 determines if the ranging attempt was successful. If it was not successful, the number of tries (a configuration parameter) is decremented in step 158 and test 160 determines if the maximum number of tries that will be attempted have been attempted. If so, step 162 concludes that unit uid has moved out of range and removes the uid of the unit being re-ranged from the encounter list 164.

If test 156 indicates the re-ranging attempt was successful, step 166 filters the ranging result to generate a filtered range F_range. A Kalman filter is used in the preferred embodiment. Step 168 then updates the filtered range and hop count and the time the unit was last seen in the encounter list.

Step 172 increments the pointer to the next uid in the encounter list, and process returns to the top of the re-ranging loop at step 148.

FIG. 12 is the process each ranging transceiver carries out to listen for beacon and report packets from other ranging transceivers and build the beginnings of an encounter list with a row for every ranging transceiver that can be-heard. Step 174 waits for a packet to be received by the ranging radio. When a packet arrives, test 176 is performed to determine if the ranging transceiver is a gateway. If so, the ranging data in the packet is uploaded over data path 106 to the computer, step 178. If not, test 180 is performed to determine from the hop count in the packet if the sender of the packet just received is closer to the gateway than this ranging transceiver. By convention gateways are assumed to have the correct time, or “master clock” and are assumed to be automatically, or manually updated periodically from an accurate time source. If the sender of the packet just received is closer to the gateway than this ranging transceiver it is assumed that the timestamp in the packet is a more accurate reflection of the current time than the clock of this transceiver, so step 182 updates the real time clock using the timestamp from the packet, and the local clock is adjusted to maintain better time. The real-time clock timestamps are not used for the time of flight calculation and are only used for keeping track of the sequences of events in the activity being monitored. Therefore, the times kept by the ranging transceivers in the ranging network, while needing to be synchronized, only need to be synchronized within a second or two margin of error. Any known way of doing this synchronization can be used for this function. Processing time in the sender and receiver and propagation time can either be ignored since those times are in the millisecond or nanosecond range and usually relatively insignificant.

When a packet has been received, step 184 updates the encounter list 164 simply by making sure there is a row in the table for the uid of the ranging transceiver from which a packet was just received. If not, a row is added and the uid is put in the uid column and the timestamp is recorded in the time column.

Test 186 then reads the forward request field in the packet to determine if the sender wants it forwarded to the gateway if the receiver is not a gateway. If the packet is to be forwarded, test 188 reads the configuration data to determine if this ranging transceiver which just received the packet is a router or a mobile. Under normal circumstances mobiles are configured not to forward packets so to conserve their battery power but it is permitted. Also under normal circumstances other units would be configured not to attempt to forward packets through a mobile, but if they did the forward request may be ignored by a mobile. If test 186 determines the packet is not to be forwarded or if test 188 determines this transceiver is not a router, processing returns to step 174. If the packet is to be forwarded and this transceiver is a router, step 190 is performed to create a packet with a header addressed to a router in the encounter list that has the lowest hop count, and then processing returns to step 174. Thus the packet “multihops” back from router to router until it reaches a gateway.

Although the invention has been described in terms of the preferred and alternative embodiments described herein, those skilled in the art will appreciate numerous modifications and alternative embodiments that do not depart from the basic teachings of the invention. All such modifications and alternative embodiments are intended to be included within the scope of the claims appended hereto.

What is claimed is:

1. An activity monitoring apparatus comprising:
a ranging network including ranging transceivers each of which is small enough to be worn by a person and each functioning to discover which other ranging transceivers are near it and how far away they are by performing a discovery and ranging process and generate ranging data that identifies the ranging transceivers involved in the ranging process and the time of the ranging encounter and functioning to store or transmit said ranging data; and
a computer having a display, input device and cursor control device and programmed with a program which displays to a user an application programmatic interface that has tools or primitives each of which is a low level event recognizer which said user can compose using said input device and/or cursor control device into inference rules which are higher level event recognizers which are then used by said computer to analyze said ranging data to recognize events regarding activity; and
a data path coupling said ranging transceivers to said computer functioning to carry said ranging data to said computer.

2. The apparatus of claim 1 wherein said ranging network is a peer-to-peer network and each ranging transceiver has a wireless transceiver having a computer programmed to control said transceiver to send and receive ranging packets and carry out said discovery and ranging process to discover which other ranging transceivers are in the vicinity and how far away each other ranging transceiver is and store ranging data resulting from said discovery and ranging process.

3. The apparatus of claim 1 wherein some of said ranging transceivers, called routers or the gateway, are coupled to alternating current power lines for power, and others, called mobiles, run on battery power, and wherein at least said mobiles include power saving means functioning to shut some or all of the circuits of the ranging transceiver down when the ranging transceiver has not moved for a predetermined interval so as to conserve battery power.

4. The apparatus of claim 1 wherein said ranging network includes some ranging transceivers which are routers, at least one ranging transceiver which is a gateway and one or more ranging transceivers which are mobiles, and wherein all of said routers, gateway and mobiles have identical circuitry and software, but said routers are capable of forwarding ranging data received from other ranging transceivers to said gateway, and all of said mobiles have configuration data which tell them they are mobiles and can be forbidden from forwarding ranging data received from other transceivers.

5. The apparatus of claim 1 further comprising communication means for communicating data between said computer and a server or other computer located remotely.

6. The apparatus of claim 1 wherein each ranging transceiver has an analysis computer integrated thereon which can do analysis of the ranging data gathered by said ranging transceiver and gathered by other ranging transceivers using a set of inference rules.

7. The apparatus of claim 3 wherein each said ranging transceiver is structured to transmit beacon packets, listen for beacon packets transmitted from other ranging transceivers and build an encounter list comprising ranging data, determine the range to every other ranging transceiver from which a beacon packet has been received by any ranging process.

8. The apparatus of claim 7 wherein each said ranging transceiver is structured to carry out the Symmetrical Double Sided Two Way Ranging process implemented by the Nanotron NA5TR1 radio ranging transceiver.

9. The apparatus of claim 1 wherein said ranging transceivers are wearable and use radio frequency ranging using time-of-flight calculation and wherein said computer is programmed to provide a user interface which provides primitives which provide the ability for a user to compose inference rules which cause the system to become a platform for event monitoring.

10. The apparatus of claim 9 wherein said ranging transceivers are ubiquitously deployed throughout the domains in which a subject being monitored operates and wherein said primitives comprise a set of primitives which are so comprehensive as to allow inference rules to be composed and used by a user of said platform to monitor the activities of the whole life of the subject within the domain or domains in which said ranging transceivers are deployed, and wherein said user interface also provides report primitives to generate results of analysis using said inference rules and trend primitives to allow analysis of said reports to determine trends.

11. The apparatus of claim 9 wherein said computer is coupled to another remote computer via communication means for transferring ranging data gathered by said ranging network to said remote computer.

12. The apparatus of claim 9 wherein each ranging transceiver is structured to transmit beacon packets which contain the entire contents of said encounter list, listen for beacon packets transmitted from other ranging transceivers and build an encounter list comprising ranging data, determine the range to every other ranging transceiver from which a beacon packet has been received by any ranging process and store said range in said encounter list.

13. The apparatus of claim 11 wherein each ranging transceiver is structured to transmit beacon packets which contain the entire contents of said encounter list, listen for beacon packets transmitted from other ranging transceivers and build an encounter list comprising ranging data, determine the range to every other ranging transceiver from which a beacon packet has been received by any ranging process and store said range in said encounter list.

14. An activity monitoring apparatus comprising:
a ranging network including ranging transceivers each of which is small enough to be worn by a person and each functioning to discover which other ranging transceivers are near it and how far away they are by performing a discovery and ranging process and generate ranging data that identifies the ranging transceivers involved in the ranging process and the time of the ranging encounter and functioning to store or transmit said ranging data;
a remote computer having a display, input device and cursor control device and programmed with a program which displays to a user an application programmatic interface that has tools or primitives each of which is a low level event recognizer which a user-of said remote computer can compose using said input device and/or cursor control device into inference rules which are higher level event recognizers which are then used by said computer to analyze said ranging data to recognize events regarding activity;
an event server computer programmed to receive ranging data from said ranging network and forward said ranging data via any communication network to said remote computer;
a data path coupling said ranging transceivers to said event server computer and functioning to carry said ranging data to said event server computer.

15. The apparatus of claim 14 wherein said ranging network is comprised of a plurality of ranging transceivers each of which is programmed to listen for beacon packets from other ranging transceivers and use radio frequency ranging to determine the range to each other ranging transceiver from which a beacon packet has been received and build an encounter list storing said ranging data and upload said ranging data to said event server computer.

16. The apparatus of claim 15 wherein one of said ranging transceivers is a gateway which is coupled to said event server computer via said data path and which is programmed to receive ranging data from said other ranging transceivers and upload said ranging data to said event server computer.

17. The apparatus of claim 16 wherein some of said ranging transceivers are programmed as routers so that they function to not only report their own ranging data to said event server via said gateway but also to forward ranging data received from said other ranging transceivers programmed as mobiles to said gateway.

18. The apparatus of claim 17 wherein at least said mobiles are small enough to wear and be carried in a pocket and are battery operated and wherein each has a power saving means for saving battery power.

19. A process carried out in a ranging transceiver, comprising:
transmitting a beacon packet from time to time;
listening for beacon packets transmitted from other ranging transceivers;
determining the range to other ranging transceivers from which a beacon packet has been received and building an encounter list of ranging data;
expunging from encounter list the identity of tranceivers that have not been seen for a specified period, and ceasing to range them until a fresh beacon packet is received from them,
reporting the contents of said encounter list to an analysis computer.

20. The process of claim 19 further comprising the steps carried out in said computer of displaying a set of primitives each of which is an event recognizer and receiving user input which defines which primitives are to be composed into one or more inference rules and how said primitives are to be composed.

21. The process of claim 20 wherein said step of building said encounter list includes the steps of storing the ID of each other ranging transceiver from which a beacon packet has been received along with the range to that ranging transceiver and its hop count in a memory.

22. The process of claim 20 wherein said steps of transmitting and reporting are the same step because each beacon packet includes the entire contents of said encounter list.
